(19) United States
(12) Patent Application Publication
(10) Pub. No.: US 2025/0265518 A1
(43) Pub. Date: Aug. 21, 2025

(54) AUTHORSHIP ACCOUNTABILITY SYSTEM

(71) Applicant: Christian BOWERS, Birmingham, MI (US)

(72) Inventor: Christian BOWERS, Birmingham, MI (US)

(21) Appl. No.: 19/060,430

(22) Filed: Feb. 21, 2025

Related U.S. Application Data
(60) Provisional application No. 63/556,132, filed on Feb. 21, 2024.

(51) Int. Cl. G06Q 10/0631

(52) U.S. Cl. CPC G06Q 10/063118; G06Q 10/063114

(57) ABSTRACT

A method of authorship management can include determining a project session has been initiated and capturing a screenshot showing a workspace of a user device. A task network determines an activity being performed based on the screenshot. The task network is a neural network trained to predict tasks being performed based on screenshot data. Time and task data associated with the activity is recorded. When the project session has been determined to be completed, a summary of the project session is generated based on the time and task data.

### BACKGROUND

Academic research has seen an exponential growth in overall publication volume, as well as the number of authors attributed to each research paper. While many researchers may be involved in some manner with a certain publication, the level of contribution of each particular author has progressively become more difficult to account for, and is not easily determined from the paper itself. In this new post-pandemic world of normalized remote work collaborations, research continues to be increasingly distributed through a variety of participants across the globe, with researchers that bring disparate contributions of wide variance in the types of collaborations (research, data science, technical guidance, writing ability, etc.) and the time spent on any individual project.

### BRIEF DESCRIPTION OF THE DRAWINGS

The detailed description is described with reference to the accompanying drawings in which:

FIG. 1 illustrates a diagram of a process of initiating a multi-author project in accordance with one or more embodiments;

FIG. 2 illustrates a diagram of a process of monitoring authorship activity by a single user in accordance with one or more embodiments;

FIG. 3 illustrates a diagram of a process of monitoring authorship activity in accordance with one or more embodiments;

FIG. 4 illustrates a diagram of a process of analyzing monitored activity to determine authorship data in accordance with one or more embodiments;

FIG. 5 illustrates example tasks in accordance with one or more embodiments;

FIG. 6 illustrates a visualization of task hours in accordance with one or more embodiments;

FIG. 7 illustrates a breakdown of task hours by author in accordance with one or more embodiments;

FIG. 8 illustrates an example project analytics in accordance with one or more embodiments.

FIG. 9 illustrates an example project task list in accordance with one or more embodiments.

FIG. 10 illustrates an example screenshot log in accordance with one or more embodiments.

FIGS. 11-17 illustrate example user interfaces in accordance with one or more embodiments.

FIG. 18 illustrates a flowchart of a series of acts in a method of determining authorship of a research paper in accordance with one or more embodiments; and

FIG. 19 illustrates a block diagram of an exemplary computing device in accordance with one or more embodiments.

### DETAILED DESCRIPTION

Academic journals, such as medical journals, legal journals, technical journals, etc., typically rely on self-reporting to determine who should be considered an author of an article, research paper, etc. and the position of the authors, which generally is intended to reflect the contribution of each author (e.g., higher listed authors have made a larger contribution to the work). Traditionally, it has been difficult to precisely quantify the exact nature and extent (e.g., how the author contributed to the work, the amount of time spent contributing to the work, etc.) of any individual author's contributions. Additionally, as the number of co-authors has increased over time, it has become nearly impossible for authors or journal editors to ensure accurate and fair authorship positions are awarded based on merit and effort spent on any specific manuscript. Currently, there is no quantitative data available regarding the level and nature of any individual author's contributions to a completed project.

Embodiments address these shortcomings by tracking how much time is spent by each author on every aspect of a scholarly project, from idea inception until publication, and generating a real-time accounting of time spent on various tasks by various authors. This authorship data allows for the quantity of time that was spent on each scholarly task, and how much was spent by each person, to be precisely calculated. Additionally, this provides a fair and accurate representation of the actual work contributed by the various co-authors on any particular manuscript since there is complete transparency of the amount of work done by each author. This transparency regarding each author's precise contributions in turn enables equitable authorship distribution. Every team member will know which co-authors performed the various tasks, and how much time was spent by each team member on those various tasks.

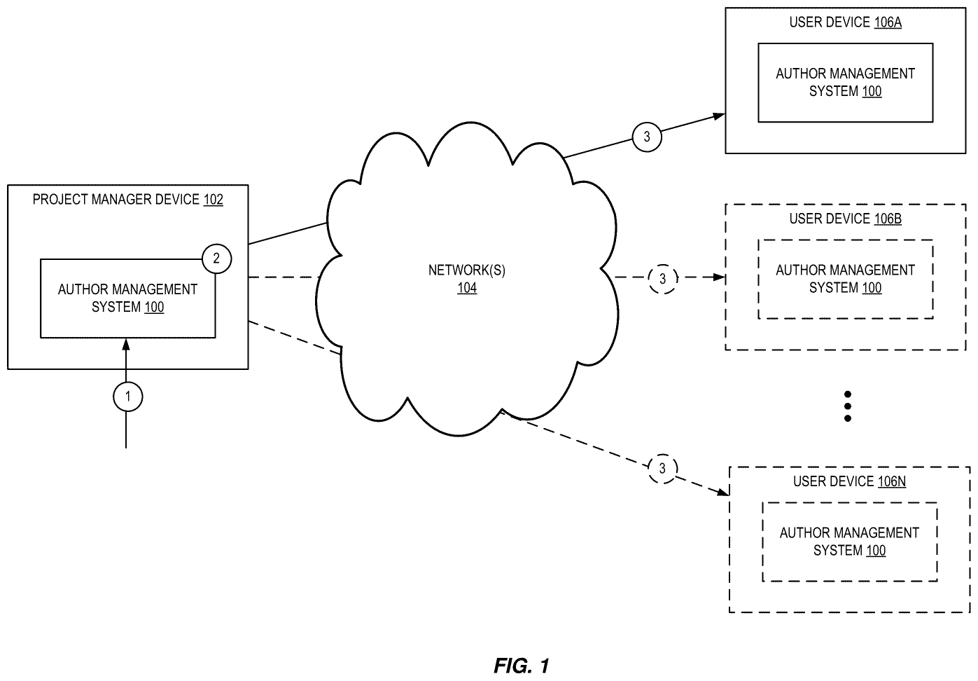

FIG. 1 illustrates a diagram of a process of initiating a multi-author project in accordance with one or more embodiments. As shown in FIG. 1, an author management system 100 can be installed on each participant's computing device. The computing device may include a desktop or laptop personal computer, a mobile device (e.g., smartphone, tablet, etc.), a virtual reality/augmented reality device (e.g., headset), or other computing device. A project manager, using project manager device 102 may install author management system 100. Author management system 100 may be a software application (or “app”) that is downloaded from an internet endpoint, app store, etc.

The author management system 100 may enable the project manager to initiate a project. For example, at numeral 1, the project manager may send a request to the author management system 100 to create a new project. This may include titling the project and providing a list of contributors. Contributors may be identified by account name, email address, or other identifier. In some embodiments, the contributors may already have accounts with the author management system, or the users may be invited to create accounts. This may include creating an account through the author management system, through a website associated with the author management system, etc. Project creation may also include assigning particular tasks to specific users. At numeral 2, the author management system 100 can create the new project and invite the identified contributors to the new project. For example, at numeral 3, message(s) may be sent over one or more networks 104 to user devices 106A-N corresponding to various invited contributors.

Each contributor may be associated with a different user device 106A-N or multiple contributors may share a device. Once the users have received the invite (e.g., via email, push notification, or other notification), the user can install a local author management system 100 and/or open an existing copy of the author management system. In some embodiments, the user may be required to grant access to one or more client systems (e.g., camera, microphone, screen, etc.) prior to continuing. Additionally, or alternatively, in some embodiments, the user may be required to complete a registration process with the author management system 100. Once complete, the author management system 100 is configured to monitor the authorship activity of the users who have access to the user device, as discussed further herein.

In some embodiments, the user can select a project they want to work on and choose which task, available for that project. The user may make these selections using various user input devices, such as pointing devices, touchscreens, retinal tracking, voice instruction, etc. In some embodiments, when the user begins a session, the user device may capture biometric information from the user. For example, an image may be captured of the user's face and facial recognition may be used to identify the user. Alternative biometric-based identification may also, or alternatively, be used. This guarantees the veracity of the person working on the project, since there is a business of ghost authorship where people pay to be made authors on manuscripts where they made no actual contributions.

In some embodiments, the first author (e.g., project manager) initiates a scientific project by creating the project in the author management system, or by entering the information on an author management website. The first author completes the initial, brief, proposed research project description and lists their planned collaborators by selecting their co-authors for that project. Co-authors can be selected from the database, or if they have not been registered, by entering their primary email address to ensure an invite is sent to them to register with the author management system so they can enroll in the project. The first author selects a number of tasks to be performed. These may be from a standard list, or a custom list provided by the project manager. In some embodiments, the available tasks may be limited based on the training of the task network.

In some embodiments, when the first author registers the proposed project, they also send the project proposal to the supervising, or senior, author, with an estimated anticipated authorship position form that includes all co-authors. The senior author can then approve the project electronically after reviewing the proposed project details, including the project outline, and the estimated authorship order, prior to official project approval. The institutional review board (IRB) section on the project form requires an approved IRB number, with the IRB approval documented to be uploaded, or the IRB exemption box marked, when appropriate. Any work or progress on the project is tracked from the moment the project is created and as collaborators are added to the project.

In some embodiments, the first author (e.g., project manager) can select a button for preliminary project time tracking if they are doing background research prior to officially organizing a project. Then, if the project commences, the background work put in by the first author will be tracked.

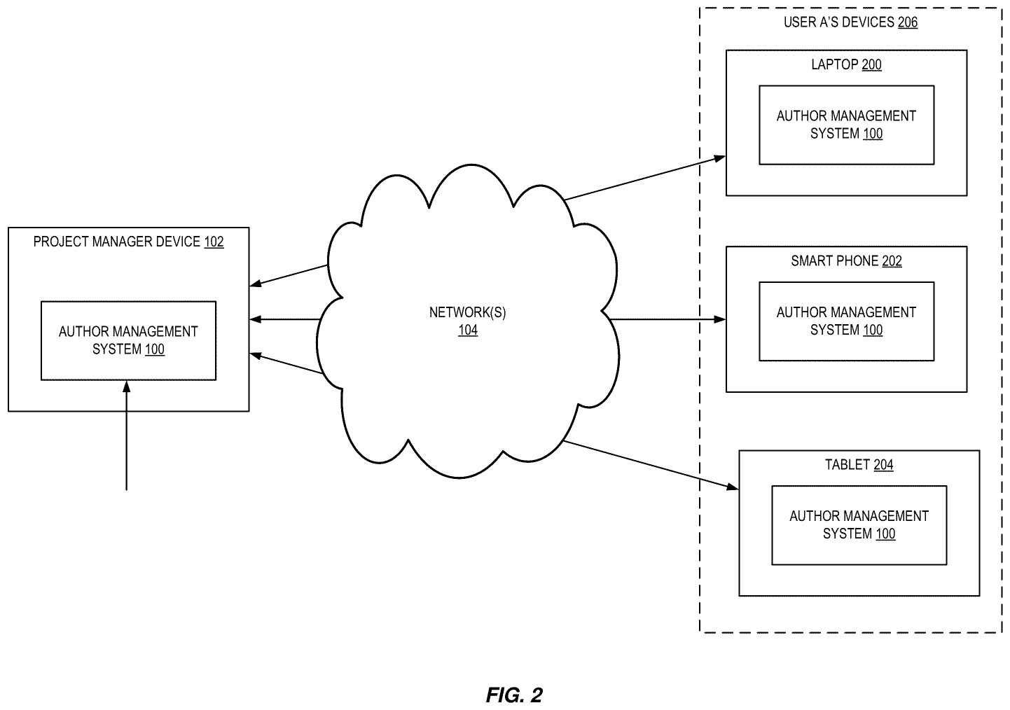

FIG. 2 illustrates a diagram of a process of monitoring authorship activity by a single user in accordance with one or more embodiments. As discussed above, an author management system 100 instance executing on a project management device 102 can monitor various user devices associated with multiple users who are contributing to a given project. Additionally, in various embodiments, a single user may have multiple registered devices which are also monitored simultaneously.

For example, as shown in FIG. 2, User A, which may represent any single contributing author, can have multiple devices registered with the author management system 100. In this example, User a has registered a laptop 200, a smart phone 202, and a tablet 204. Each device includes author management monitors activity on its corresponding device and communicates data representing that activity to the author management system 100 on the project manager device 102. For example, timestamps, active application name, activity status (e.g., in power saving mode, receiving user input, etc.), or other metadata can be communicated from each device. The timestamp data allows for the activity on each device to be correlated and current activity on each device can be directly compared. For example, if laptop 200 is currently active in a document editing application, but smart phone 202 is currently in a personal phone call (e.g., as determined by call metadata) then the author management system 100 can automatically adjust the active time spent by User A to reflect the personal call. Likewise, if User A is editing figures on tablet 204 and editing text on laptop 200, the author management system 100 can track both activities as related to the current authorship project.

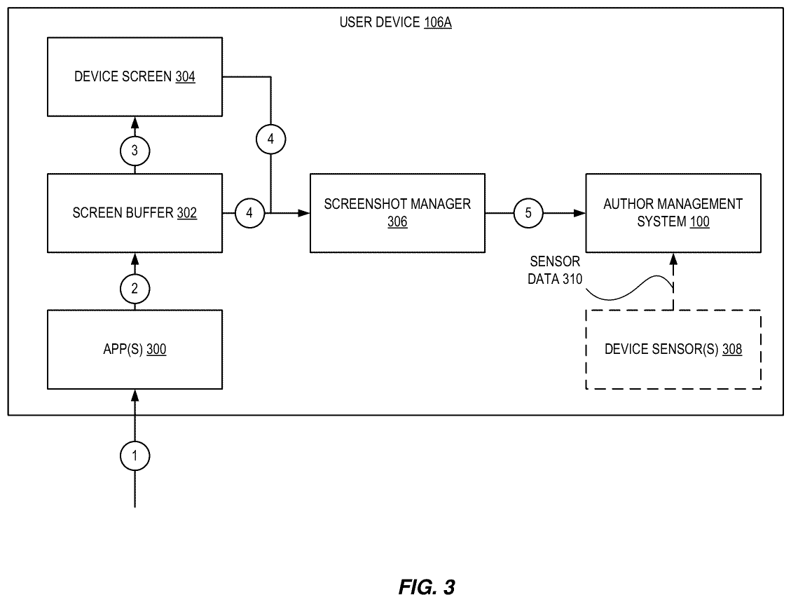

FIG. 3 illustrates a diagram of a process of monitoring authorship activity in accordance with one or more embodiments. In some embodiments, the author management system 100 can monitor author activity based on changes to the screen of the user's device. As shown in FIG. 3, the user may interact with one or more apps 300 executing on the user device. These apps may include, e.g., word processing applications, data management/visualization applications, spreadsheet applications, slide show creation applications, graphic design applications, etc. These applications may primarily execute on the user device 106A and/or maybe web applications with are hosted remotely and accessed through a thin client application, such as a web browser.

Rather than attempting the interface with the various applications that the user may use to perform tasks related to the project, the author management system may instead capture screenshots. The specific changes being made (e.g., exact text contribution, layout changes, etc.) are not needed to determine the task being performed or the amount of time taken to perform the task. As such, directly interfacing with the apps 300 is not necessary. Instead, by monitoring the changes to the user device's screen, the author management system 100 can predict the task (or non-task) activity being performed by the user and determine the amount of time spent on the predicted task.

At numeral 1, the user inputs changes to the app in which they are working. This results in the screen being updated to reflect the changes. This may include updating a screen buffer 302, as shown at numeral 2, which is then output to the device screen 304 at numeral 3. In some embodiments, alternative display hardware configurations may lead to more or fewer screen buffers in use, depending on implementation. A screenshot manager 306 may obtain a screenshot from the screen buffer 302 or the screen 304 at numeral 4. For example, the screenshot manager 306 may be configured to periodically request a screenshot via a built-in function of the user device (e.g., via an operating system, etc.). Additionally, or alternatively, the screenshot manager 306 may intercept and copy data as it is provided to the screen, request a copy of the data directly from the screen buffer, etc.

At numeral 5, the screenshot manager 306 can provide the screenshots to the author management system 100. In some embodiments, the screenshot manager 306 may provide the screenshots in batches. Alternatively, the screenshot manager 306 may stream the screenshots to the author management system as they are received. In a further alternative implementation, the screenshot manager 306 may maintain a buffer (or other data store) of screenshots which are then requested as needed by the author management system 100 for further processing.

Optionally, in some embodiments, user device 106A may also include one or more device sensors 308. Such device sensors 308 may include cameras, retina/eye/orbit tracking sensors, gyroscope (or other orientation/attitude sensor), satellite navigation/positioning sensors (e.g., GPS, Galileo, BeiDou, or other global navigation satellite system (GNSS)) audio sensor, light sensor, etc. These sensors can each produce sensor data 310 that may also be provided to author management system 100. For example, eye tracking sensors and/or user facing cameras can collect data used to determine user attentiveness, while a gyroscope and GNSS sensor may collect device orientation and position data. The sensor data may optionally be provided to the author management system 100 for further analysis.

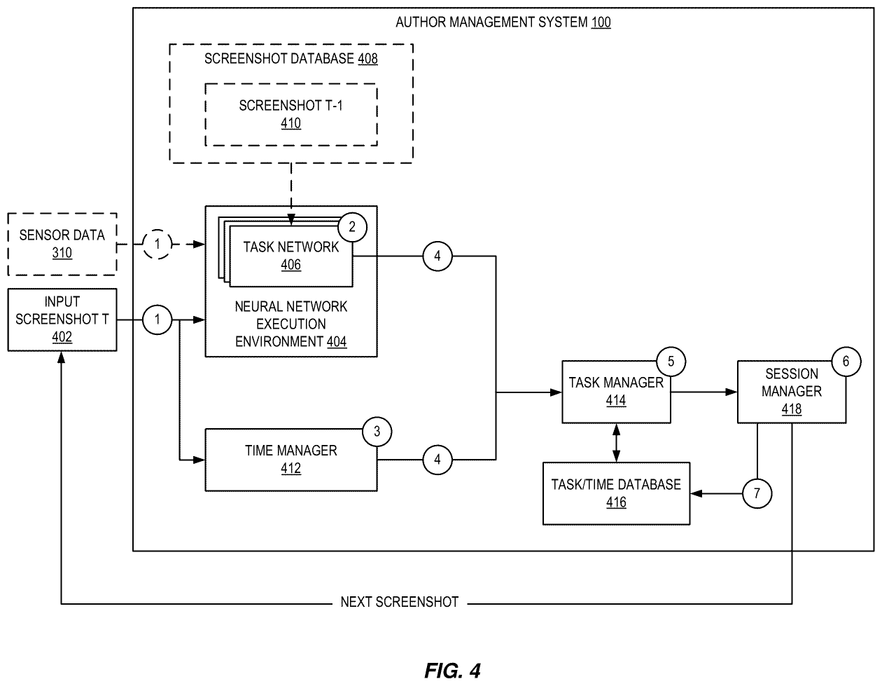

FIG. 4 illustrates a diagram of a process of analyzing monitored activity to determine authorship data in accordance with one or more embodiments. As discussed, the author management system 100 may identify tasks being performed based on screenshots captured from a user's screen as they work on a given project. As shown in FIG. 4, an input screenshot 402 may be received by the author management system 100 at numeral 1. The input screenshot 402 may be captured at time t.

The screenshot 402 may be received by a task network 406. The task network 406 may be a machine learning model, such as one or more neural networks, trained to predict a task being performed based on one or more input screenshots. A neural network, or machine learning model, may be trained using training inputs to perform a function. For example, the neural network may implement various deep learning techniques to learn to extract, predict, or otherwise analyze data to perform a function based on the data. As shown in FIG. 4, the task network 406 may execute in a neural network execution environment 404. The neural network execution environment 404 may include hardware, software, libraries, etc. needed for the execution of the task network 406. For example, in some embodiments, the user device may include dedicated hardware and/or software resources for neural network execution.

In some embodiments, the task network 406 may be trained to identify a task that has been performed based on the input screenshot. For example, the task network 406 may be implemented as a classifier which outputs a prediction for multiple tasks that the task network has been trained to identify. In some embodiments, the task network may base its prediction on the input screenshot at time t and one or more prior screenshots (e.g., screenshot t−1 410, etc. stored in screenshot database 408). This allows the task network 406 to predict the task based on changes to the screen over time.

At numeral 2, the task network predicts a task which the user is performing. The tasks that the task network is trained to predict may include tasks associated with preparing an academic or research paper. The tasks may also include tasks that are not related to preparing an academic or research paper. This allows for the task network 406 to identify when the user is not engaged in the project. For example, the user may be distracted, asked to assist with a different project, or otherwise engaged in some non-project task(s).

In addition to identifying tasks, in some embodiments, the author management system 100 can also determine an amount of time the tasks are performed. For example, when a screenshot is received, it may also be provided to time manager 412, as shown at numeral 4. In some embodiments, time manager 412 can record a time stamp associated with the screenshot. The time stamp may be metadata included with the input screenshot 402 and/or may be assigned by the time manager 412.

As discussed, in some embodiments, sensor data 310 may optionally be collected by device sensors connected to or in communication with a user device. Where such sensor data is available, in some embodiments, the sensor data 310 can also be provided to the author management system 100 for analysis. For example, the sensor data may be provided with the screenshot to the task network 406. Alternatively, the screenshot data may be provided to one network, while the sensor data is provided to a different network with the outputs of each network being provided to the task manager and analyzed along with the data provided by the time manager. For example, the sensor data may be analyzed by a task network trained to predict task efficiency, e.g., based on observed user attentiveness. This task efficiency prediction may be combined with the task prediction and the time spent to adjust up or down a score assigned to the user related to their task performance. In some embodiments, such a task efficiency network may be trained based on performance and attention data, collected from a cohort of users over time, to predict a work efficiency score.

At numeral 4, the predicted task(s) and the time stamp may be provided to task manager 414. The task manager 414 can associate the time stamp data with the predicted task(s), at numeral 5. In some embodiments, the task manager 414 maintains a task/time database 416 which includes the predicted task(s) and time stamp data over time. Once the current screenshot has been classified and time stamped, a session manager 418 can determine whether there are additional screenshots to be processed, at numeral 6. This may include checking a screenshot buffer for more screenshots, sending a request to screenshot manager 206, or other action to determine whether a task is still being performed by the user. At numeral 7, once the session is complete, the task/time database 416 can be updated to indicate the end of the session.

In some embodiments, the author management system 100 on each user device can periodically provide its task/time data from the local task/time database to a central instance of the author management system 100. For example, the project manager's author management system may receive copies of task and time data from all other user devices' author management system instances. Additionally, or alternatively, all task and time data may be collected by another management system or service, such as a cloud-based tracking system. This may have the benefit of each user being able to view/audit the task and time data to ensure it matches their own records.

In some embodiments, a senior author and first author can always view an internal master log of all work entries done by all authors, on all project tasks, as this is updated in real time whenever an author is working on the project. Additionally, in some embodiments, screenshots from the beginning & end of a session may be recorded, so that documentation is maintained to provide evidence and support for work done on the project by various authors. In some embodiments, summary details may be generated regarding what work they accomplished during their logged time period for each project work entry that they input. This may be performed at the session, sub-session, or project level.

In some embodiments, whenever work interruptions occur, researchers can quickly hit a pause button (or other UI element) or otherwise interact with the author management system 100 to indicate that a pause should be recorded (e.g., using voice commands the user may verbally request a pause). In some embodiments, the user may be prompted with a question on the screen that the researcher can quickly brush away or verbally indicate to dismiss, whenever they are ready to resume research.

In some embodiments, AI/ML algorithms are implemented to optimize giving appropriate credit when research is being performed. For example, if the user decides to watch the end of a major sporting event, but forgets to pause the system, then the system will still automatically not count that interruption time as research work, since the task network has been trained to identify activity that matches specific tasks and activity that indicates no tasks are being performed.

In some embodiments, the first and senior authors automatically receive updates in their comprehensive project work log whenever any work is done on the project by a member of the research team. Researchers can always ask questions regarding the research work log if there are any questions regarding a specific research time period, since summaries are always sent to them after they conclude a research work session. As discussed, the system can identify when a user is browsing the internet (Facebook, ESPN, news, etc.) vs doing actual research, as the system is trained to automatically separate research work from a break, leisure time, or recreational web surfing.

In some embodiments, the author management system can be calibrated for each researcher by using AI to learn how each researcher works on projects. For example, each researcher may be associated with their own, fine-tuned task network. The system identifies how each researcher organizes their work and articles by using the monitored history of that user in other projects. Researchers select the task they are going to work on (e.g. manuscript editing, Background Literature review, etc.) and then initiate work-tracking and then it will track all of the work done on that task. If the researcher selects another task, or even a different project altogether, it will automatically track the work on the selected project & task and that work can be tracked in real time with a pie chart, for in-real time visual tracking. For example, any time a user is reading a journal article, the system tracks the time spent reading the article and taking notes.

Any time a researcher wants to do some background reading on an idea that may become a research project, they can create their own preliminary project, by selecting “hypothesis” and spending time researching their idea. This can be converted to a formal project in the future if it is formally pursued.

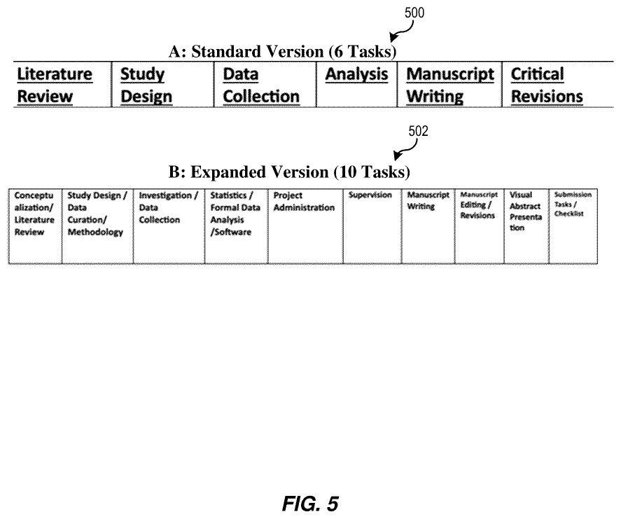

FIG. 5 illustrates example tasks in accordance with one or more embodiments. As discussed, when a new project is created, the project manager may select tasks associated with the project. As shown in FIG. 5, this might include lists of tasks provided by the author management system, such as standard tasks 500 or expanded tasks 502. These specified tasks for each project are the categories that will be used by all researchers when tracking their work during the project. Alternatively, the user may define a custom set of tasks either from these tasks or including additional tasks.

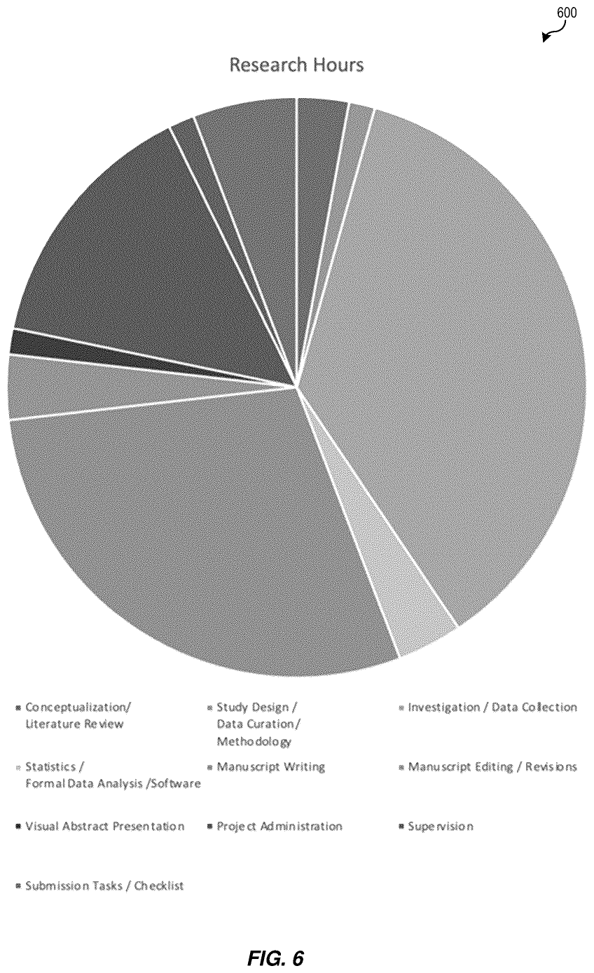

FIG. 6 illustrates a visualization of task hours in accordance with one or more embodiments. The major medical journals now require the authors on a manuscript to justify their authorship designation by having all the manuscript's authors agree with a visual chart 600 that breaks down all authorship contributions into the various authorship tasks. The journals mandate that all authors must meet the authorship criteria and they require all authors to sign that the visual chart's breakdown of authorship contributions is valid and accurate. However, these authorship assignments are frequently inaccurate with major misrepresentations, or even complete fabrications. There are even companies allowing wealthy applicants to pay to have their names listed on publications. Embodiments provide the first method of ensuring an accurate and fair representation of the actual work done by each individual author for each task of the project. If there are major disparities in work spent on a project and the authorship positions originally planned, these will be highlighted with the final pie chart graph when the final manuscript is ready to submit, and authorship positions can then be altered for fairness, in an equitable fashion.

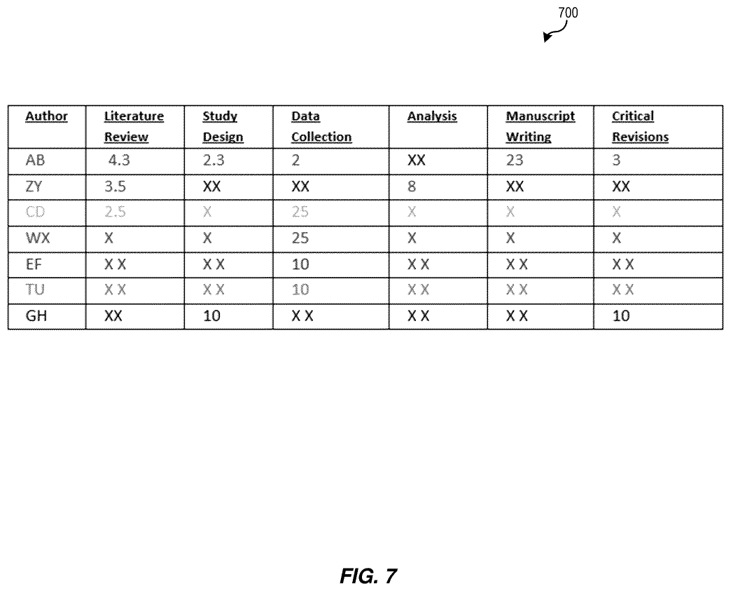

FIG. 7 illustrates a breakdown of task hours by author in accordance with one or more embodiments. In this example, a summary of time spent on each task by each author is illustrated in a table form 700. This may correspond to the visual pie chart demonstrating time spent on each part of the project by each author.

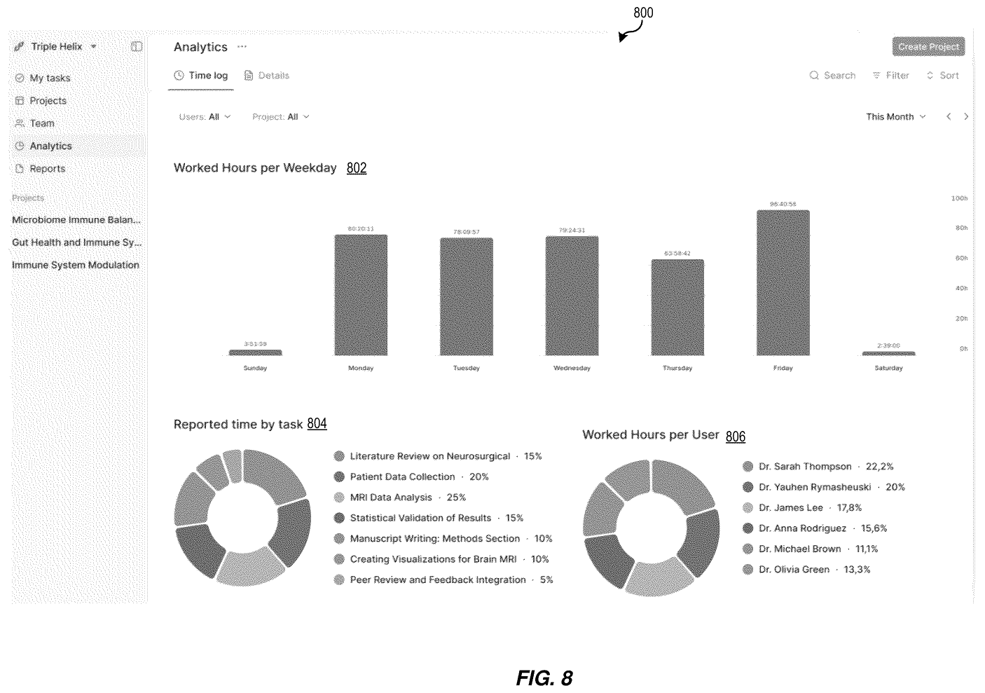

FIG. 8 illustrates example project analytics in accordance with one or more embodiments. As shown in FIG. 8, the author management system can present analytics 800 related to a given project. For example, the analytics can include time worked 802 which may be broken down by day and may cover time spent over a given period (e.g., week, month, year or other period). In some embodiments, the analytics may also include a breakdown of time spent by task 804 and time spent per user 806.

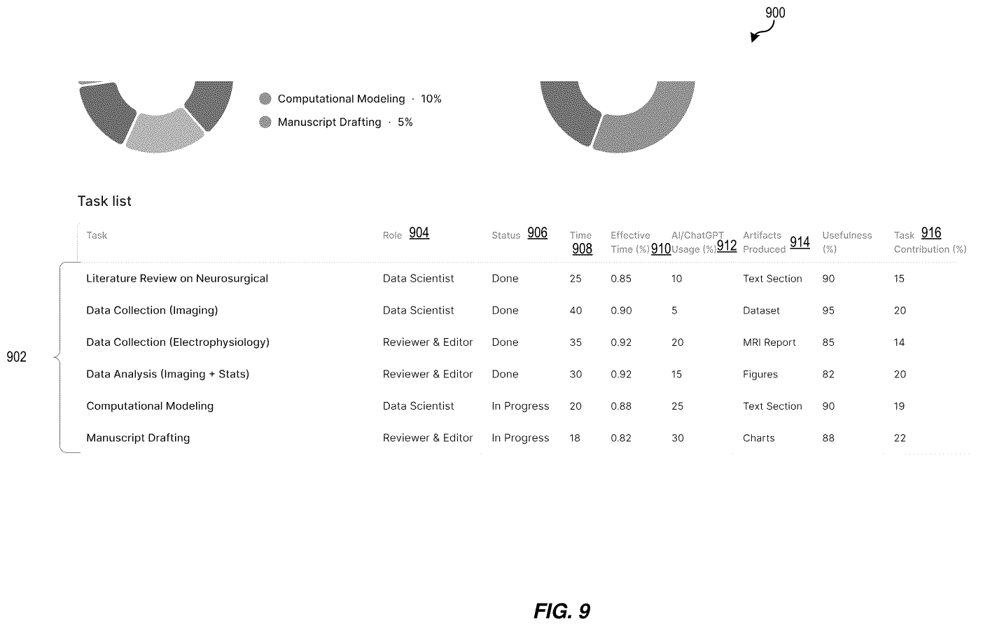

FIG. 9 illustrates an example project task list 900 in accordance with one or more embodiments. In the example of FIG. 9, the task list can include various tasks 902 as determined by the authorship management system, as discussed above. In addition to task name, the task list can also indicate the role 904 of the person responsible for the task and the status 906 of each task. In some embodiments, the task list can also indicate the time 908 taken so far on each task as well as an effective time rate which may represent how efficiently the task was performed. In some embodiments, the use 912 of specific tools may also be monitored. For example, the use of intelligent tools such as ChatGPT or other AI-based tools can be monitored and reflected in the task list. Additionally, the specific artifact 914 that is produced may also be indicated. The artifact may represent the specific work performed (e.g., document text, dataset management, figure preparation, etc.). In some embodiments, the task list can also indicate the overall task contribution percentage 916 to the project.

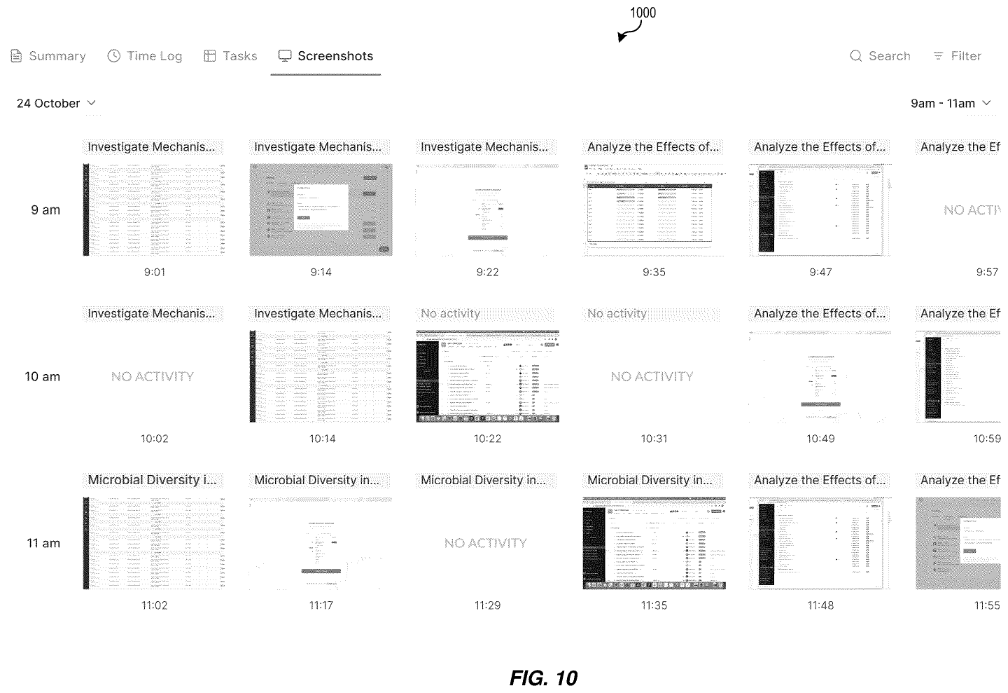

FIG. 10 illustrates an example screenshot log 1000 in accordance with one or more embodiments. As discussed above, in some embodiments, screenshots may be collected from one or more user devices as the user works. The screenshot log 1000 may represent screenshots stored in a screenshot database, a temporary cache, or other storage option.

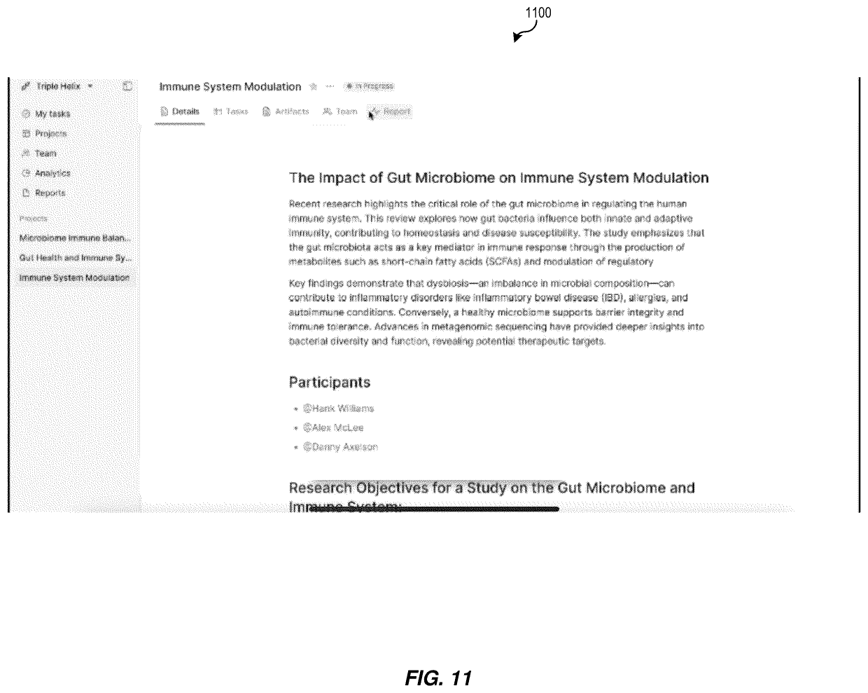

FIGS. 11-17 illustrate example user interfaces in accordance with one or more embodiments. In the example user interface of FIG. 11, a user can view the details 1100 of a specific project. As shown, this may include an abstract or summary of the project along with participants and potentially other information. The project may be selected from projects that the user is a participant in or otherwise has access to (e.g., as a reviewer, manager, etc.). Through the user interface the user can view task status, user contribution, and other information, as discussed.

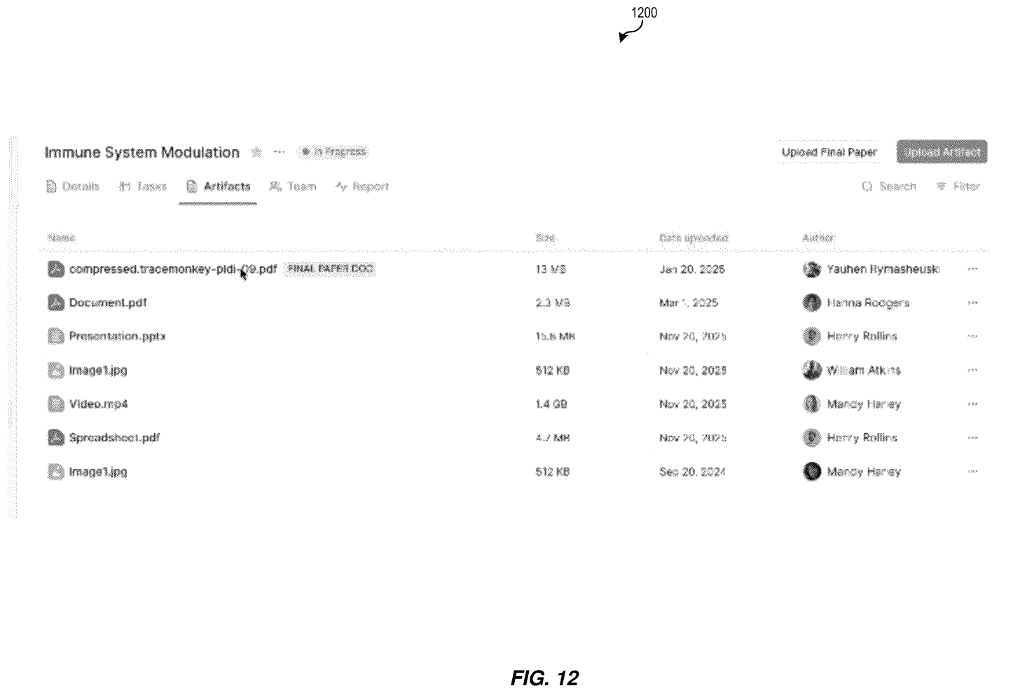

In the example of FIG. 12, an artifacts tab 1200 can show the specific artifacts that have been produced or are in production related to a specific project. In this example, the project produced a final paper, presentation, video, etc. Each of these items is referred to as an artifact. Through this tab, the user can view each artifact and/or review task and other information associated with the artifact(s).

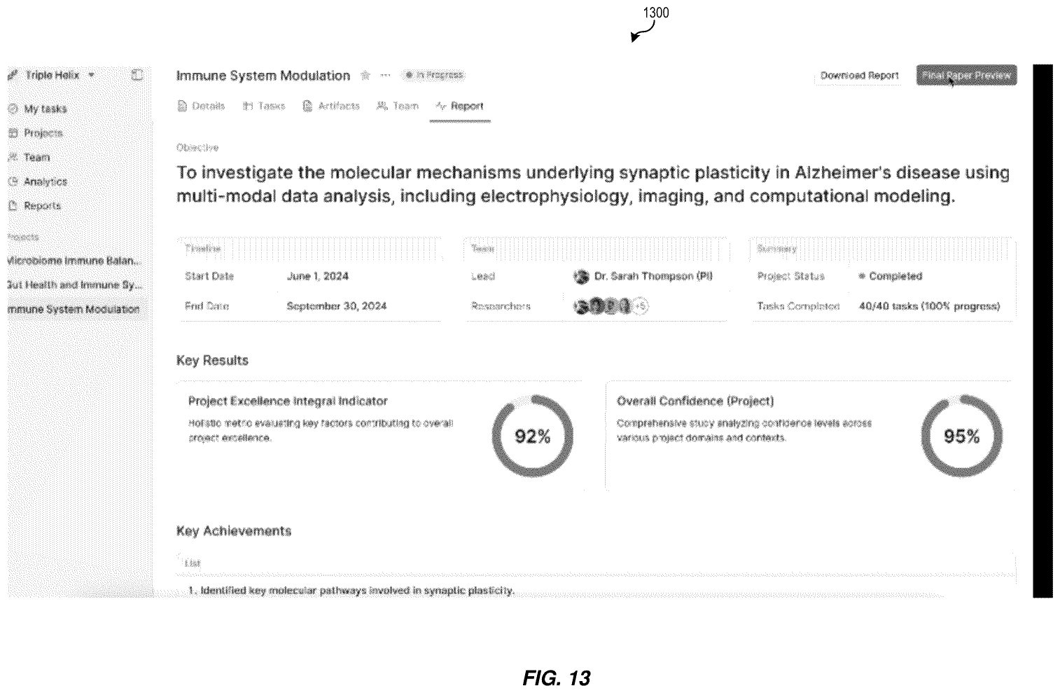

FIG. 13 shows an example of a report tab 1300 of the user interface. The report tab 1300 can include specific project information such as start and end date, lead/project manager, participants, project status, etc. The report tab 1300 can also include metrics describing the project, such as those related to project excellence and confidence.

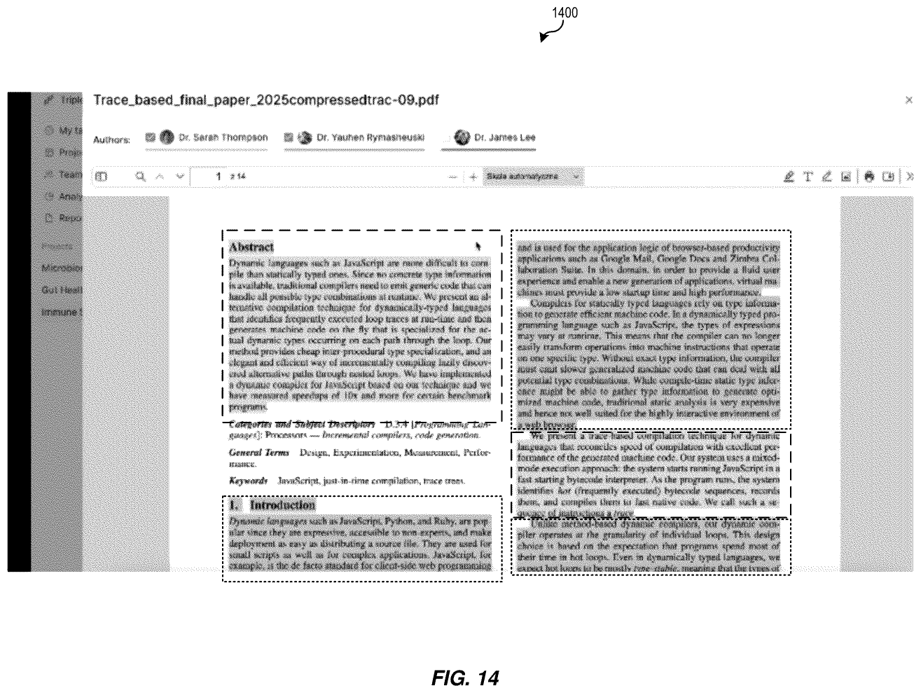

FIG. 14 shows an example artifact 1400 broken down by authorship. In the example of FIG. 14, the text shown in dashed boxes is authored by one participant and the text shown in dotted boxes is authored by a different participant. Since the project has been tracked from the beginning, work produced by each other is traceable to a specific participant. This level of granularity allows for more precise authorship to be claimed and validated.

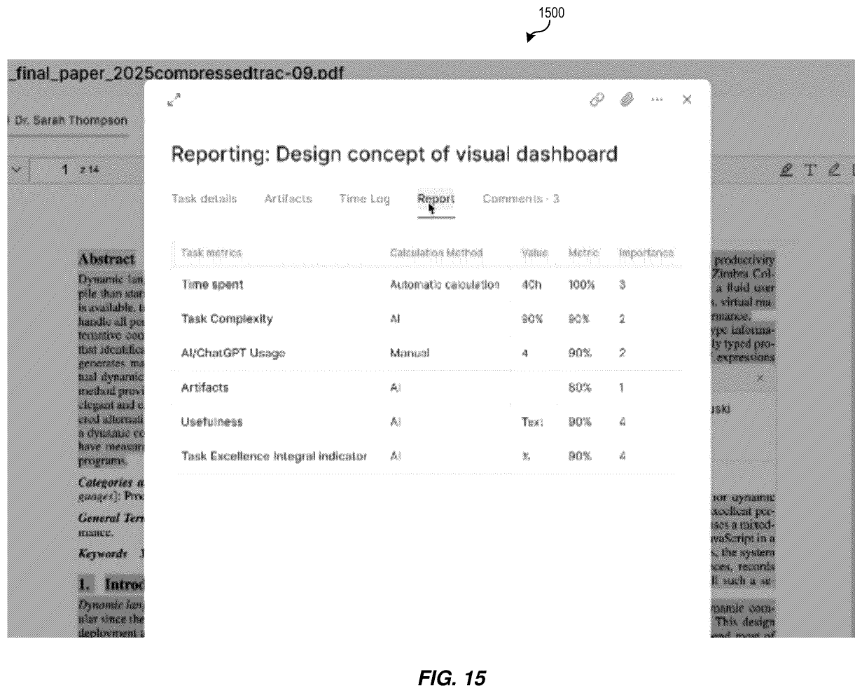

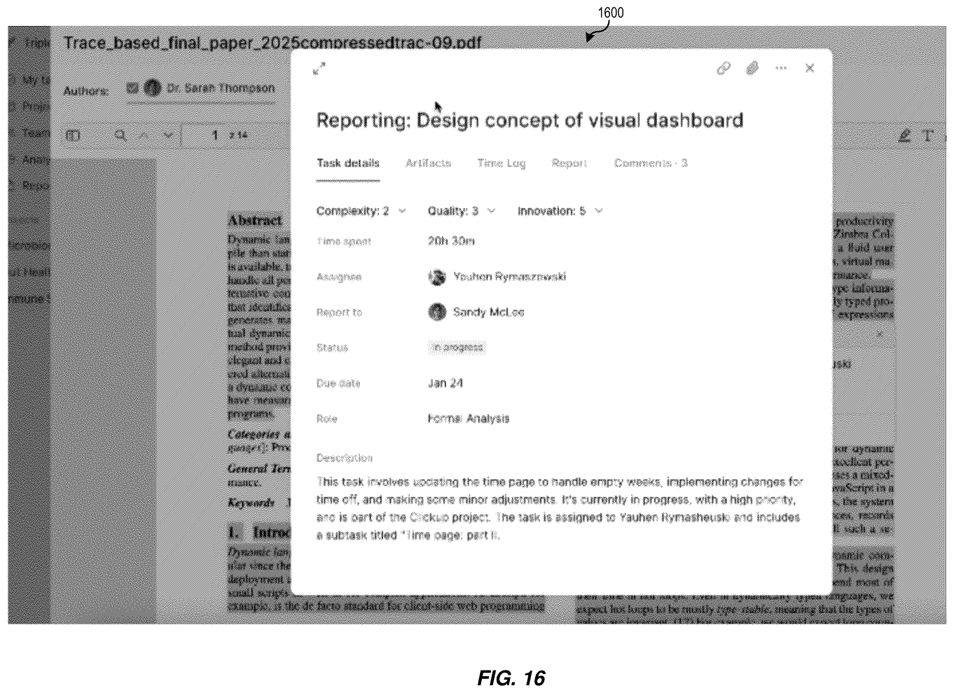

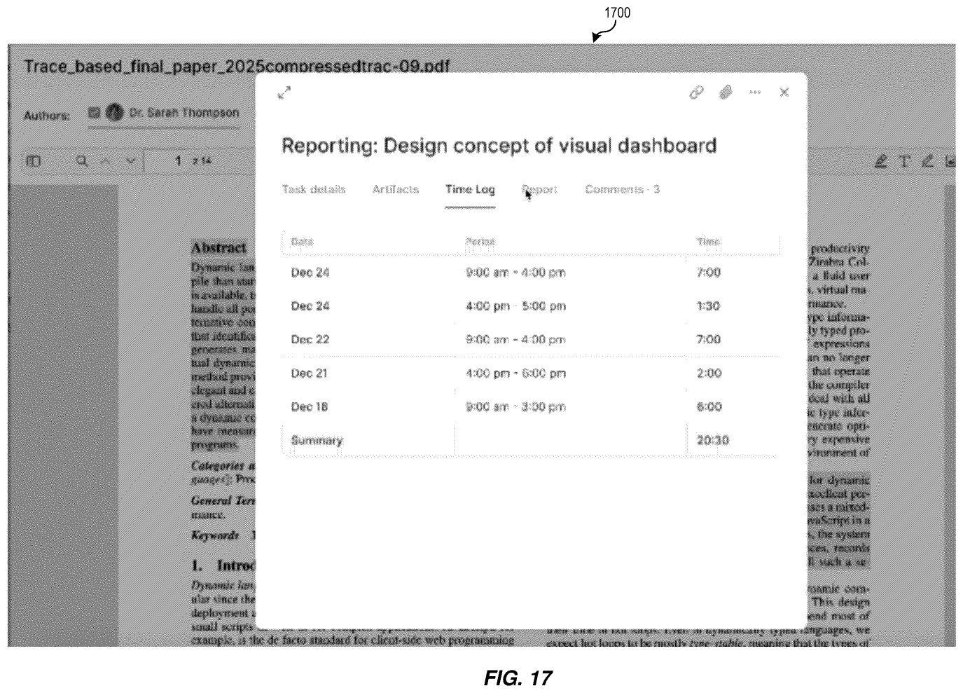

FIG. 15 shows a report tab 1500 of the user interface. As shown in FIG. 15, the report can show the time spent, task complexity, AI/ChatGPT usage, Artifacts, Usefulness, and Task Excellence Integral Indicator. For each task metric, a calculation method is also indicated (e.g., time may be calculated automatically while others may be determined using a machine learning- or AI-based system). Similarly, FIG. 16 shows a task details tab 1600 which includes a description of the task performed, the participant, the participant's manager (if any), current task status, etc. FIG. 17 shows a time log tab 1700 which indicates when and for how long a given task was worked on.

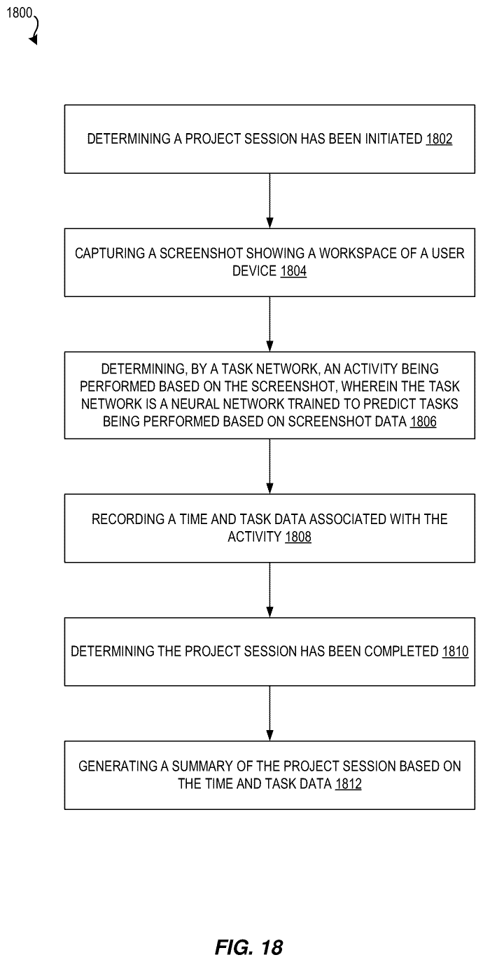

FIG. 18 illustrates a flowchart of an exemplary method in accordance with one or more embodiments. The method described in relation to FIG. 18 may be performed with fewer or more steps/acts or the steps/acts may be performed in differing orders. Additionally, the steps/acts described herein may be repeated or performed in parallel with one another or in parallel with different instances of the same or similar steps/acts.

FIG. 18 illustrates a flowchart 1800 of a series of acts in a method of determining authorship of a research paper in accordance with one or more embodiments. In one or more embodiments, the method 1800 is performed in a digital medium environment. The method 1800 is intended to be illustrative of one or more methods in accordance with the present disclosure and is not intended to limit potential embodiments. Alternative embodiments can include additional, fewer, or different steps than those articulated in FIG. 18.

As illustrated in FIG. 18, the method 1800 includes an act 1802 of determining a project session has been initiated. For example, the user may select a graphical user element to start the project session. Additionally, or alternatively, the author management system may automatically determine whether a project session has been initiated based on screenshot analysis of the user device. In some embodiments, when an artifact that was created as part of a project is determined to have been opened by a user, a project session may be initiated.

As illustrated in FIG. 18, the method 1800 includes an act 1804 of capturing a screenshot showing a workspace of a user device. In some embodiments, capturing a screenshot showing a workspace of a user device, further includes recording a plurality of screenshots during the project session, wherein each screenshot is captured at a regular interval of time.

As illustrated in FIG. 18, the method 1800 includes an act 1806 of determining, by a task network, an activity being performed based on the screenshot, wherein the task network is a neural network trained to predict tasks being performed based on screenshot data. In some embodiments, determining, by a task network, an activity being performed based on the screenshot, wherein the task network is a neural network trained to predict tasks being performed based on screenshot data, further includes providing the screenshot and a previous screenshot to the task network to identify the activity being performed. In some embodiments, the task network is trained to identify project tasks and non-project tasks and wherein the activity corresponds to a project task or a non-project task.

As illustrated in FIG. 18, the method 1800 includes an act 1808 of recording a time and task data associated with the activity. In some embodiments, the author management system may include a clock and timer which activates when the project session is started and an activity is detected. In some embodiments, the timer may pause automatically based on user activity on the user device or a different user device. For example, if the user takes a phone call, browses an Internet shopping site, or other personal activity, the project timer may be paused until project activity is again detected.

As illustrated in FIG. 18, the method 1800 includes an act 1810 of determining the project session has been completed. In some embodiments, the project session may be completed when the artifacts in progress have been closed. Additionally, or alternatively, the user may manually indicate the project session is complete by interacting with a graphic element within the user interface. In some embodiments, the project session may be determined to be complete based on a screenshot analysis of the user device(s).

As illustrated in FIG. 18, the method 1800 includes an act 1812 of generating a summary of the project session based on the time and task data. In some embodiments, the summary may be provided along with a manuscript of the project to fulfill a submission requirement of the project. For example, this summary may be referred to as a “Project DNA” or “Project double helix” which tells the story of who did what with the project.

In some embodiments, the method further includes receiving a request to create a new project, receiving project details, including a project name, project description, and user data, and sending requests to one or more users to join the project using the user data.

In some embodiments, the method further includes receiving a request from the one or more users to register for the project and issuing credentials to the one or more users for the project.

In some embodiments, the method further includes uploading the time and task data associated with the project session to a data store and generating a real-time summary of the project based on the time and task data stored in the data store.

In some embodiments, the author management system can monitor activity not performed on a computing device. For example, an image capture device (e.g., camera, smart phone with built-in camera, webcam, etc.) may be used to capture a user's work area. This may include capturing images of paper notetaking, reading a physical copy of an article, etc. In such instances, the image capture device may be mounted to a stand or similar device such that it can be directed at the work area. The image capture device may then periodically capture and transmit images of the work area to the author management system for analysis. In some embodiments, the image capture device may capture a before and after image of the work area that can be submitted as work for a timed session.

In some embodiments, the author management system's user interface may include a conspicuous, easily accessible “privacy” button. When selected (e.g., tapped, clicked, requested via voice command, or otherwise interacted with or invoked), the author management system will shut off all audio and video recordings and stop tracking time for a myriad of privacy moments that pop up during an activity. Likewise, the user interface may include a recording indicator to make clear to the user that a recording is in progress. For example, there may be a conspicuous brightness/blinking/symbol shown in the user interface. In some embodiments, this indicator may be configurable by the user. Similarly, when privacy mode is on, a different indicator may be shown which makes it clear that no audiovisual recording is occurring. Such indication may be presented as a bright visual alert, a sound, etc.

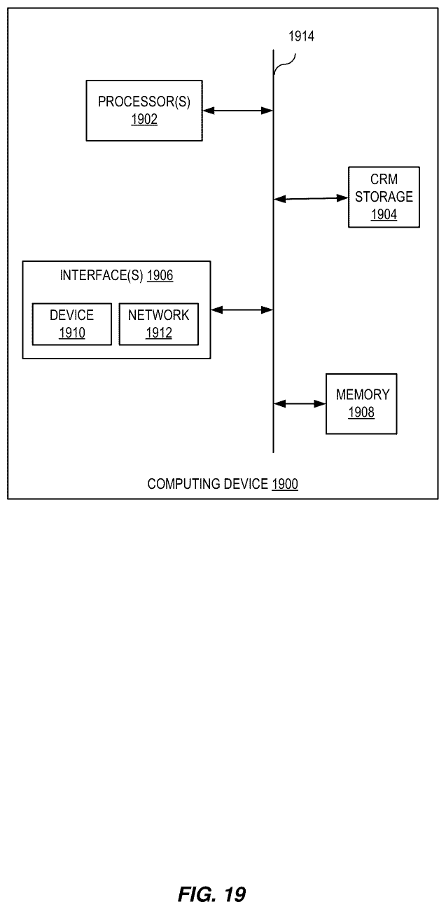

FIG. 19 illustrates a block diagram of an exemplary computing device in accordance with one or more embodiments. In various embodiments, the author management system may be implemented on, include, or otherwise use a computing device such as the computing device 1900. As shown by FIG. 19, the computing device 1900 includes one or more processor(s) 1902, computer readable storage medium/media 1904, various interfaces 1906 (including device/I/O interfaces 1910 and communication/network interfaces 1912), and a memory 1908. These components may be communicatively coupled via a bus 1914. The bus 1914 may be implemented as a hardware or software bus which facilitates communication between the various components of the computing device. The computing device 1900 can include fewer or more components than those shown in FIG. 19.

In some embodiments, processor(s) 1902 may include hardware for executing instructions, such as those making up a computer program. For example, processor(s) 1902 may retrieve (or fetch) instructions from a cache, memory, storage medium, etc. and decode and execute the instructions. In various embodiments, the processor(s) 1902 may include one or more graphics processing units (GPUs), accelerators, central processing units (CPUs), field programmable gate arrays (FPGAs), systems on chip (SoC), or other processor(s) or combinations of processors.

In some embodiments, the computing device 1900 includes a computer readable storage medium 1904 (such as a storage drive or other storage device) which includes non-transitory computer readable storage for storing data or instructions. For example, the CRM storage 1904 can comprise a non-transitory storage medium described above. The CRM storage 1904 may include a Universal Serial Bus (USB) drive, hard disk drive (HDD), flash memory or a combination of these or other storage devices.

As shown in FIG. 19, the computing device 1900 also includes various interfaces 1906. These interfaces 1906 may include device interfaces 1910 and network interfaces 1912. The device interfaces 1910 enable a user to provide input to (such as user strokes), receive output from, and otherwise transfer data to and from the computing device 1900. Such input devices that may communicate with the computing device via the device interfaces 1910 may include a mouse, keypad or a keyboard, a touch screen, camera, optical scanner, network interface, modem, other I/O devices or a combination of such I/O devices/interfaces 1910. The touch screen may be activated with a stylus, a finger, or other touching implement. The device interfaces 1910 may also enable communication with output devices, such as a graphics engine, a display, display drivers, speakers and audio drivers, etc. In certain embodiments, device interfaces 1910 enable graphical user interfaces and/or any other graphical content to be presented to the user. Input devices may then be used to interact with the graphical user interface.

As shown, the computing device 1900 can also include one or more communication interfaces 1912. A communication interface 1912 can include hardware, software, or both. The communication interface 1912 can enable communication (e.g., packet-based communication) between the computing device and one or more other computing devices 1900 or one or more networks. For example, communication interface 1912 may be implemented as a network interface controller (NIC) or network adapter for communicating with an Ethernet or other wire-based network or a wireless NIC (WNIC) or wireless adapter for communicating with a wireless network, such as a WI-FI.

The computing device 1900 includes memory 1908, such as Random Access Memory (“RAM”), Read Only Memory (“ROM”), a solid state disk (“SSD”), Flash, Phase Change Memory (“PCM”), or other types of data storage. The memory 1908 may be internal or distributed memory. which is coupled to the processor(s) 1902. The memory 1908 may be used for storing data, metadata, and programs for execution by the processor(s).

Computer-readable media that store computer-executable instructions are non-transitory computer-readable storage media (devices). Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” may include data link(s) that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
determining a project session has been initiated;
capturing a screenshot showing a workspace of a user device;
determining, by a task network, an activity being performed based on the screenshot, wherein the task network is a neural network trained to predict tasks being performed based on screenshot data;
recording a time and task data associated with the activity;
determining the project session has been completed; and
generating a summary of the project session based on the time and task data.

2. The method of claim 1, further comprising:
receiving a request to create a new project;
receiving project details, including a project name, project description, and user data; and
sending requests to one or more users to join the project using the user data.

3. The method of claim 2, further comprising:
receiving a request from the one or more users to register for the project; and
issuing credentials to the one or more users for the project.

4. The method of claim 1, wherein capturing a screenshot showing a workspace of a user device, further comprises:
recording a plurality of screenshots during the project session, wherein each screenshot is captured at a regular interval of time.

5. The method of claim 4, wherein determining, by a task network, an activity being performed based on the screenshot, wherein the task network is a neural network trained to predict tasks being performed based on screenshot data, further comprises:
providing the screenshot and a previous screenshot to the task network to identify the activity being performed.

6. The method of claim 5, wherein the task network is trained to identify project tasks and non-project tasks and wherein the activity corresponds to a project task or a non-project task.

7. The method of claim 1, further comprising:
uploading the time and task data associated with the project session to a data store; and
generating a real-time summary of the project based on the time and task data stored in the data store.

8. A non-transitory computer-readable storage medium storing executable instructions which, when executed by a processing device, cause the processing device to perform operations including:
determining a project session has been initiated;
capturing a screenshot showing a workspace of a user device;
determining, by a task network, an activity being performed based on the screenshot, wherein the task network is a neural network trained to predict tasks being performed based on screenshot data;
recording a time and task data associated with the activity;
determining the project session has been completed; and
generating a summary of the project session based on the time and task data.

9. The non-transitory computer-readable storage medium of claim 8, wherein the operations further include:
receiving a request to create a new project;
receiving project details, including a project name, project description, and user data; and
sending requests to one or more users to join the project using the user data.

10. The non-transitory computer-readable storage medium of claim 9, wherein the operations further include:
receiving a request from the one or more users to register for the project; and
issuing credentials to the one or more users for the project.

11. The non-transitory computer-readable storage medium of claim 8, wherein the operation of capturing a screenshot showing a workspace of a user device, further comprises:
recording a plurality of screenshots during the project session, wherein each screenshot is captured at a regular interval of time.

12. The non-transitory computer-readable storage medium of claim 11, wherein the operation of determining, by a task network, an activity being performed based on the screenshot, wherein the task network is a neural network trained to predict tasks being performed based on screenshot data, further comprises:
providing the screenshot and a previous screenshot to the task network to identify the activity being performed.

13. The non-transitory computer-readable storage medium of claim 12, wherein the task network is trained to identify project tasks and non-project tasks and wherein the activity corresponds to a project task or a non-project task.

14. The non-transitory computer-readable storage medium of claim 8, wherein the operations further include:
uploading the time and task data associated with the project session to a data store; and
generating a real-time summary of the project based on the time and task data stored in the data store.

15. A system comprising:
a memory storing computer executable instructions; and
a processing device coupled to the memory, wherein the computer executable instructions, when executed by the processing device, cause the system to perform operations including:
determining a project session has been initiated;
capturing a screenshot showing a workspace of a user device;
determining, by a task network, an activity being performed based on the screenshot, wherein the task network is a neural network trained to predict tasks being performed based on screenshot data;
recording a time and task data associated with the activity;
determining the project session has been completed; and
generating a summary of the project session based on the time and task data.

16. The system of claim 15, wherein the operations further include:
receiving a request to create a new project;
receiving project details, including a project name, project description, and user data; and
sending requests to one or more users to join the project using the user data.

17. The system of claim 16, wherein the operations further include:
receiving a request from the one or more users to register for the project; and
issuing credentials to the one or more users for the project.

18. The system of claim 15, wherein the operation of capturing a screenshot showing a workspace of a user device, further comprises:
recording a plurality of screenshots during the project session, wherein each screenshot is captured at a regular interval of time.

19. The system of claim 18, wherein the operation of determining, by a task network, an activity being performed based on the screenshot, wherein the task network is a neural network trained to predict tasks being performed based on screenshot data, further comprises:
providing the screenshot and a previous screenshot to the task network to identify the activity being performed.

20. The system of claim 19, wherein the task network is trained to identify project tasks and non-project tasks and wherein the activity corresponds to a project task or a non-project task.
